(19) United States
(12) Patent Application Publication
(10) Pub. No.: US 2007/0107991 A1
(43) Pub. Date: May 17, 2007

(54) Progressive bidirectional safety gear

(75) Inventor: Francisco de Asis Mateo Mur, Pina De Ebro (Zaragoza) (ES)

Correspondence Address: BIRCH STEWART KOLASCH & BIRCH, PO BOX 747, FALLS CHURCH, VA, 22040-0747, US

(73) Assignee: DYNATECH, DYNAMICS & TECHNOLOGY, S.L.

(21) Appl. No.: 11/408,950

(22) Filed: Apr. 24, 2006

(30) Foreign Application Priority Data
Nov. 8, 2005 (EP) 05381052.9

(51) Int. Cl. B66B 5/16

(52) U.S. Cl. 187/351

(57) ABSTRACT

Progressive bidirectional safety gearthat allows to brake the car both in an upward and downward direction, formed by a main block in charge of the engagement action comprising a floating brake-shoe disposed over an elastic element and by a set of rollers that move independently of each other, and on another hand comprises a linkage associated to the main block and means to maintain the linkage in its resting and central position. The proposed system allows to make the brake-shoe rest on the guiderail in a perfectly flat manner, and allows the block to be smaller than the elastic element, as well as making the entrance of the roller as smooth as possible during the engagementing action.

### OBJECT OF THE INVENTION

The object of the present invention is a progressive bidirectional safety device for elevators, also known as safety gear. This is, it relates to a system that allows braking against the elevator guiderails, both in an upward and downward direction.

The present invention is characterised by the elements comprising the safety system, which consists of a floating brake-shoe system plus an elastic element in combination with two rollers that move in an independent manner, so that when the engagement is engaged the brake-shoe will rest on the guide as flatly as possible, preventing the uneven wear of the guiderail, all of this due to the shape of the elastic element.

The present invention is also characterised by the linkage system associated to the two rollers, which allows an independent action of the two rollers depending on whether the brake is applied when travelling in an upward or downward sense.

It also describes a system for centring the safety system supported directly by the linkage system.

Therefore, the present invention lies within the field of systems or means used for braking elevators against their guiderails, both in an upward and downward direction, known in the field as safety devices and safety gears.

### BACKGROUND OF THE INVENTION

Some prior safety devices of elevators are based on the use of two mobile brake-shoes or one fixed brake-shoe and a roller, or one fixed brake-shoe and two rollers that move simultaneously attached by one or more auxiliary parts.

In general, these and other progressive safety gears have the drawback that the pressure exerted on the guiderail, as well as the manner in which it is exerted, leaves uneven marks on said guiderail as the brake-shoe does not press uniformly on the guiderail. This results in an uneven wear of the surface of the brake-shoe. The reason for this is that the safety device is not perfectly perpendicular to the guiderail against which it must brake for several reasons, such as small misalignments in its mounting, chassis folding tolerances, etc.

Until now all elevator safety devices are based on the use of elastic elements contained in the block, so that it is necessary for the block to be larger than the elastic element in order to contain it. This has the drawback that the larger the elastic element the greater the size required of the block. The present invention allows the block to be smaller than the elastic element, with the resulting savings in material.

Currently, safety devices are placed directly on the chassis or frame. The safety device object of this invention is attached to the linkage system. This linkage system is provided with a system that allows the sideways displacement of the safety device so that the roller entrance is smoother at the time of engagement.

Therefore, the object of the present invention is to develop a progressive safety gear that overcomes the aforementioned drawbacks and allows bi-directional braking, both in an upward and downward direction, wherein said braking takes place such that the brake-shoe can adapt to the guiderail when resting on it in a perfectly flat manner, so that the mark left by the brake-shoe on the guiderails is as uniform as possible, due to its even distribution. A further object is to allow the block to be smaller than the elastic elements and to be provided with means such that at the time of engaging the system the entrance of the roller is as smooth as possible.

### DESCRIPTION OF THE INVENTION

The invention taught for a progressive bidirectional elevator safety allows to brake the car when the speed governor detects an overspeed situation.

The system comprises a main block, a linkage system mounted in connection with the main block and means for keeping the linkage system in its central or rest position.

The main block is in turn formed by means that when suitably actuated brake a guiderail that runs along the main block. On one side it is composed of a brake-shoe and elastic element assembly and on the other of a set of rollers that move independently, suitably actuated by the linkage system.

The brake-shoe used for the engagement is not attached rigidly to any other part, neither by screws nor by any other attachment means. In the resting position the brake-shoe is retained on the block by the wedge-like shape of the brake-shoe's lateral faces.

It is possible to retain the brake-shoe by using an auxiliary part or a stair-like design on the lateral part of the brake-shoe that carries out the same function as the wedge-like shape.

The brake-shoe is placed over the elastic element, which basically consists of two beams placed opposite one another with their ends resting on each other, separated by a certain length. When the brake-shoe presses on the central part of the elastic element the latter allows the brake-shoe to move somewhat so that it can rest properly on the guiderail of the elevator that will brake.

As the elastic element controls the force that the safety gear must apply, this control can be achieved by a plate that can be canged in length, so that canges the separation of supports of back beam. Also the force lever be changed by changing the thickness of the beams, which may be identical or different. It is also possible to change the stiffness of the elastic element by changing the length of the beams since, as mentioned above, the block may be smaller than the elastic element.

The linkage system basically consists of a pullrod joined by a pin to a lever. The lever has a link on which run the ends of rods which are in turn connected to the rollers, this last segment of the rods running through curved orifices made in intermediate pieces that mark the path to be followed by the rollers.

On another hand the means used to maintain the linkage system in its central or resting position comprise two parallel plates: an upper plate integrally attached to the main plate of the linkage; and a bottom plate that can swivel about both of its ends. Between these plates are placed some bushings. Some screws are placed passing through the two plates and the bushings placed between the plates. On the end of these screws are springs compressed by nuts.

Housed and attached between the two plates and in its central part is a square shaft attached to the main linkage plate and joined to the latter's lever, so that if the lever is displaced by the rod the main square shaft will turn, so that the bottom plate of the means used to maintain the linkage in its central position will swivel to one of the sides, pressing against one of the compressed springs. In this way, in absence of the action of the rod the springs will restore the original position of the main square shaft and therefore that of the linkage lever, thereby restoring the resting position of the rollers.

### DESCRIPTION OF THE DRAWINGS

To complete the description provided below and in order to aid a better understanding of its characteristics, the present descriptive memory is accompanied by a set of drawings whose figures represent the most significant details of the invention for purposes of illustration only and in a non-limiting manner.

FIG. 1 shows a front view of the inside of the safety device object of the invention.

FIG. 2 shows a front view of the linkage system of the safety device and the brake brake-shoe mounted on it.

FIG. 3 shows a perspective view of the complete safety device, showing the safety gear, the linkage system and the means used to keep the linkage system in its central or resting position.

FIG. 4 shows a cross section view of the safety gear object of the invention supported by the linkage system.

FIGS. 5A and 5B represent the displacement of the lever resulting from the action of a rod, showing the displacement of the rollers.

FIG. 6 shows a perspective view of the complete safety device, showing the safety gear, the linkage system and the means used to keep the linkage system in its central or resting position.

FIGS. 7A and 7B respectively show an elastic element as used in FIG. 1 with its operational design and an alternative elastic element.

FIG. 8 shows an alternative embodiment in which the rollers have been replaced by moving brake-shoes.

FIG. 9 shows an application of a safety device in a single direction, in the case shown for a downward sense.

FIGS. 10A and 10B show two alternative embodiments in which the elastic element is placed behind the rollers.

### PREFERRED EMBODIMENT OF THE INVENTION

A preferred embodiment of the proposed invention is described in what follows with reference to the figures.

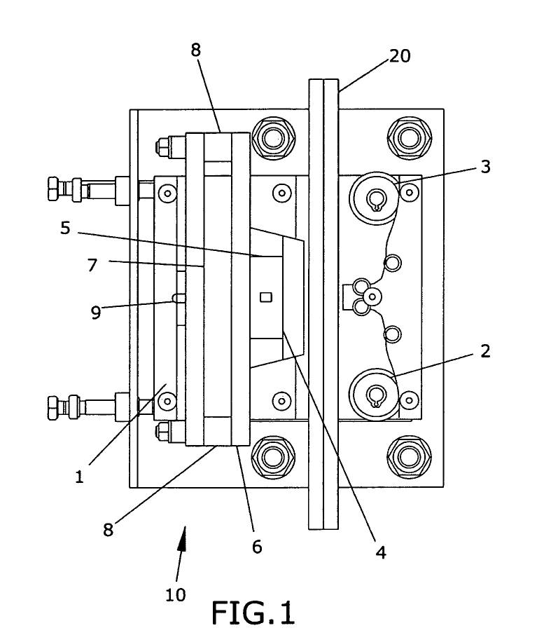

FIG. 1, as described above, represents a front view of the safety device (1) showing the presence of a guiderail (20) between a set of rollers (2) and (3), shown in their resting position, and engagement means consisting of a brake-shoe (4) in contact with an auxiliary piece (5) over an elastic element (10) formed by two parallel beams (6) and (7), separated a certain distance by meant of end supports (8). The assembly of the elastic element (10) rests on the support (9) and this in turn rests on the main block (1) and is attached at its central part and free at its ends, so that it may be longer than the safety device block.

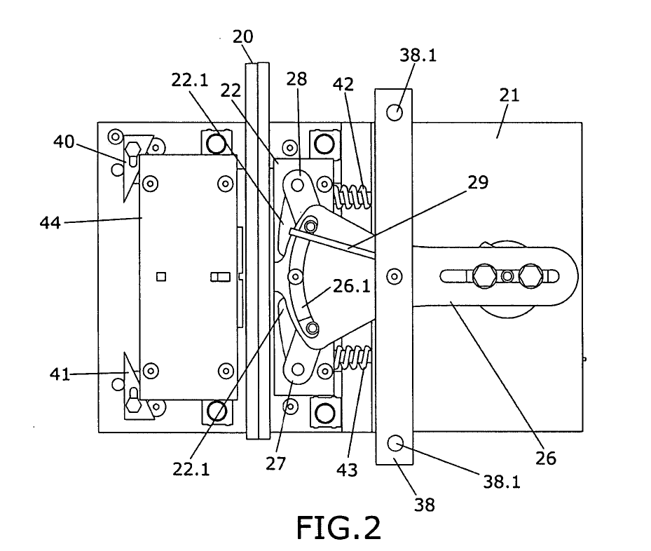

If the elevator is in a free fall situation, the roller (2) on the bottom part of the block is carried by the linkage (FIG. 2) upwards until the central part of the block, so that the roller engagementes the guiderail (20) against the brake-shoe (4). Said brake-shoe is displaced, moving the auxiliary piece (5) which compresses the elastic element (10) constituted by pieces (6), (7) and (8). The force exerted when compressing the elastic element presses the brake-shoe (4) against the guiderail (20) and the friction between the elements allows the car to slow down until it stops entirely.

In case of an uncontrolled upward motion of the elevator the roller (3) on the top part of the block will be carried down by the linkage (FIG. 2) to the central part of the block, so that the roller will engagement the guiderail (20) against the brake-shoe (4). Said brake-shoe is displaced, moving the auxiliary piece (5) which compresses the elastic element (10). The force exerted when compressing the elastic element (10) presses the brake-shoe (4) against the guiderail (20) and the friction between the elements allows the car to slow down until it stops entirely.

The brake-shoe (4) is not attached rigidly to any other part, neither by screws, adhered nor by any other attachment means. In the resting position the brake-shoe is retained on the block by the wedge-like shape of the brake-shoe's lateral faces. It is also possible to retain the brake-shoe by using an auxiliary part or a stair-like design on the lateral part of the brake-shoe that carries out the same function as the wedge-like shape.

The elastic element basically consists of two beams placed opposite one another and with their ends resting on each other, separated by a certain length. When the brake-shoe presses on the central part of the elastic element the latter allows the brake-shoe to move somewhat so that it can rest properly on the guiderail of the elevator that will brake.

FIG. 2 shows a front view of the assembly of the main block placed on the linkage. The linkage consists of a lever (26) attached to a main plate (21). Joined to this lever by a pin is a pullrod (38) provided with orifices (38.1), to which is joined the carle that acts on the pullrod and therefore pulls the lever (26).

The lever (26) has an arc-shaped link (26.1)inside which run independently some lugs that emerge from rods (27) and (28), which are joined on their other end to the rollers (2) and (3) (FIG. 1). The emergent part of the rollers pass through slits (22.1) made in the intermediate part (22) of the linkage system.

The lever (26) is provided with a spring at its union to the pullrod (38) which allows to maintain the rollers (2) and (3) in their resting position in the safety device.

Acting on the pullrod (38) makes the lever (26) move, displacing one of the two rods (27) or (28) and thus one of the two rollers independently.

In addition, it can be seen that the assembly of the main block of the safety is supported by the main linkage plate, which is housed in two slits made in the block for its sideways motion, which acts as a centring system in the engagement process, its movement being limited on one side by stop wedges (40) and (41) and on the other by springs (42) and (43) attached to the main linkage plate.

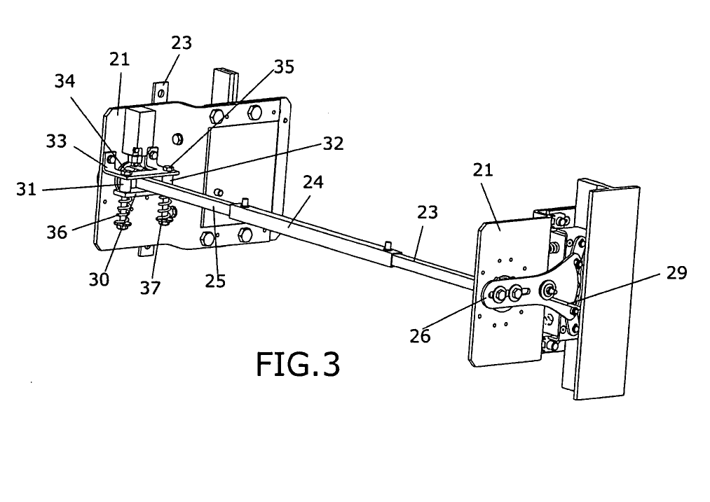

FIG. 3 shows the means used to maintain the linkage in its central or resting position, which are attached on the main plate (21).

These means are conformed by an upper plate (33) and a lower plate (30), wherein the upper plate (33) is integrally joined to the main plate (21) and rests on its ends by bushings (31) and (32) and on a bottom plate (30). Screws (34) and (35) cross both plates (33) and (30) and the bushings (31) and (32), which on their lower ends have nuts that compress springs (36) and (37).

The force applied by the springs (36) and (37) maintain the bottom plate (30) in a horizontal position in contact with the bushings (31) and (32). On another hand the bottom plate is in contact with a main square shaft (25) that is joined at its end with the lever (26), so that when the lever turns by action of the pullrod (38) the main square shaft (25) is turned, so that the bottom plate (30) swivels about one of the sides to compress one of the springs (36) and (37), such that when the action on the pullrod (38) is no longer exerted and by the action of the springs (36) and (37) the plate, the main square shaft (25) and the lever (26) recover their original resting position.

When an uncontrolled downward motion or a free fall occurs the mechanism that triggers the linkage (speed governor) pulls up on the lever through a carle connected to the pullrod (38) joined by a pin to the linkage lever (26). In this case the square shaft (25) turns the plate (30) about the bushing (31) and compresses the spring (37). When the force is no longer applied on the pullrod (38) the lever (26) will return to the resting position by action of the spring (37).

Similarly, when there is an uncontrolled upward motion the mechanism that triggers the linkage (speed governor) pulls down on the lever through a carle connected to the pullrod (38) joined by a pin to the linkage lever (26). In this case the square shaft (25) turns the plate (30) about the bushing (32) and compresses the spring (36). When the force is no longer applied on the pullrod (38) the lever (26) will return to the resting position by action of the spring (36).

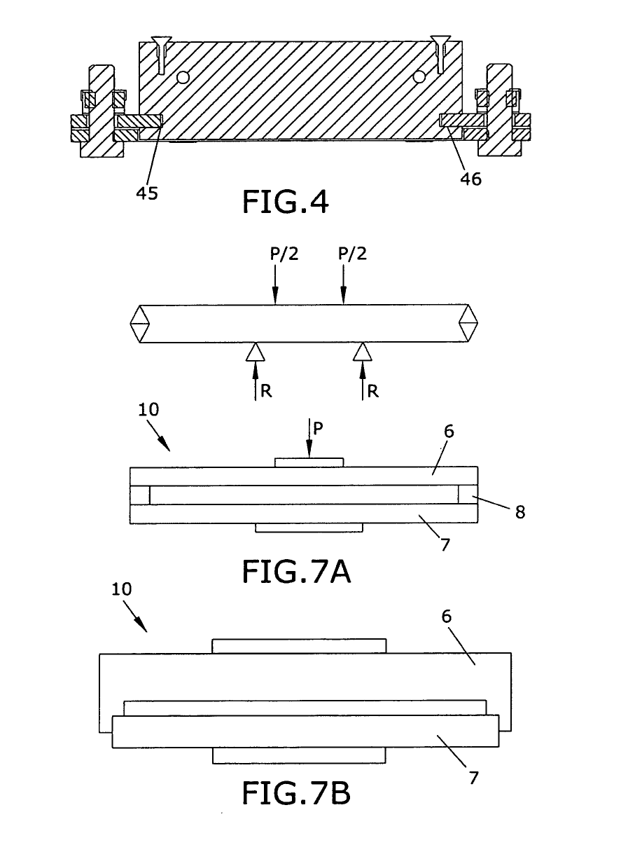

FIG. 4, which represents a cross section of the safety device object of the invention, shows that the main plate is housed in slits (45) and (46) made in the safety block (44).

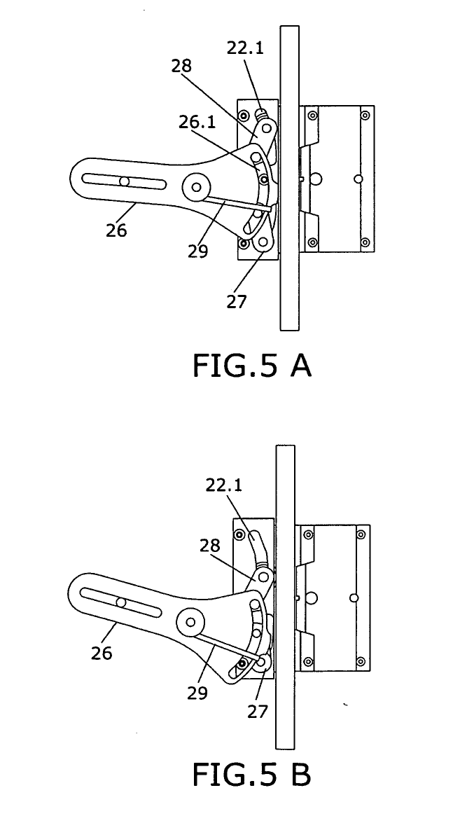

FIGS. 5A and 5B show the manner in which the linkage assembly moves when the pullrod is actuated, representing a downward displacement of the lever (26), showing how initially the end of the link (26.1) meets the lug that emerges from the rod (28) to then carry it in its displacement inside the slit (22.1), thereby carrying with it the roller (3); it is also shown that the rod (27) is not displaced at all.

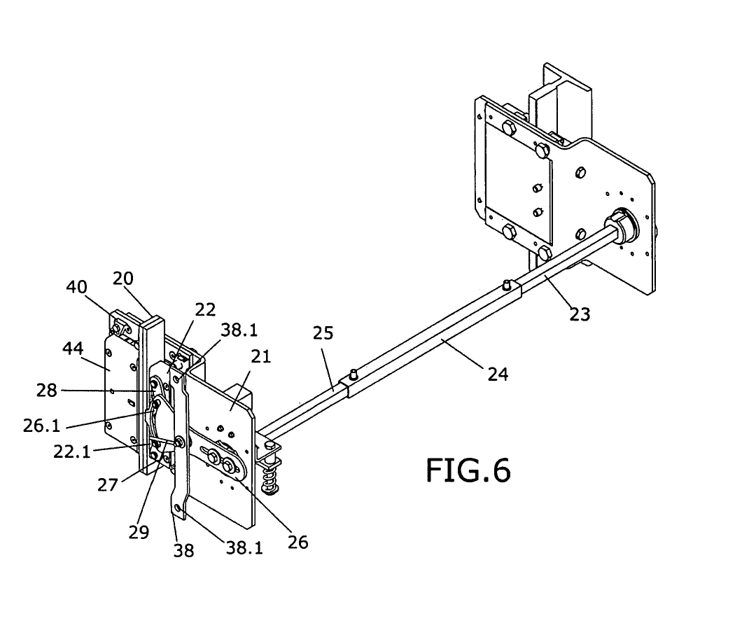

FIGS. 3 and 6 shows the complete mounted assembly. It is worth noting the main square shaft formed by the pieces (25), (26) and (27) that joins the two safety devices disposed on each of the main plates (21), only one of which is actuated, the action being transmitted by the assembly formed by the pieces (23), (24) and (25).

The main square shaft (25)is joined to the linkage system passing through the means that maintain the linkage in its central or resting position, while the other end of the main shaft is joined at its segment (23) to the other linkage and safety gear.

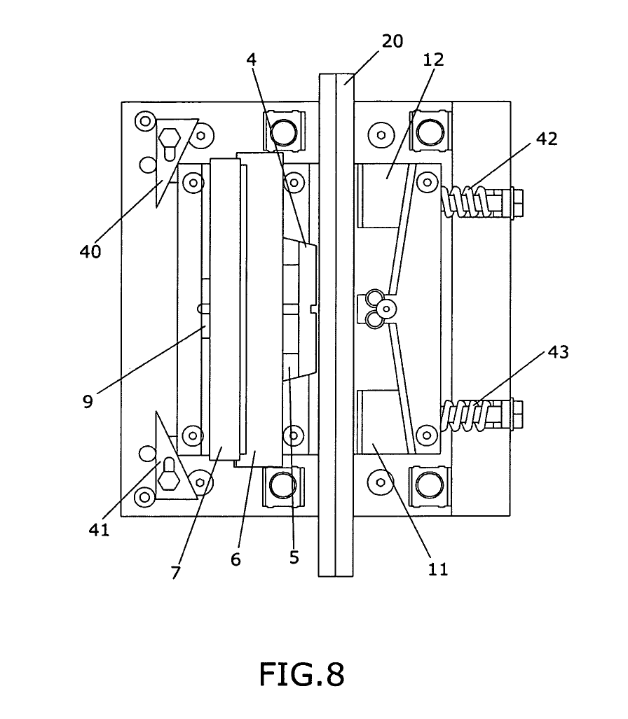

FIG. 7A shows how the elastic element is formed by two beams (6) and (7), separated by a certain distance and supported at their ends by the end supports (8). In an alternative embodiment, the end supports are eliminated and one of the beams, sheet (6), which receives the pressure directly from the brake-shoe, has a C-shaped configuration with stair-shaped ends that rest on the other ends of the sheet (7).

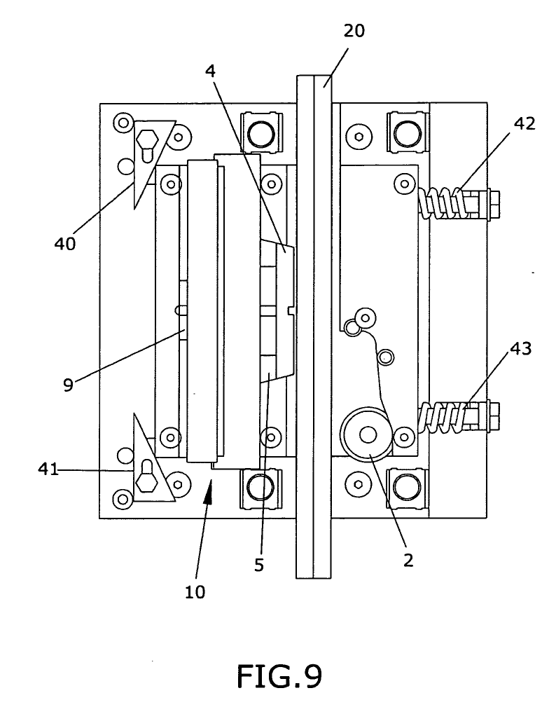

As relates to the rollers, they may be replaced by moving brake-shoes (11) and (12) as shown in FIG. 8.

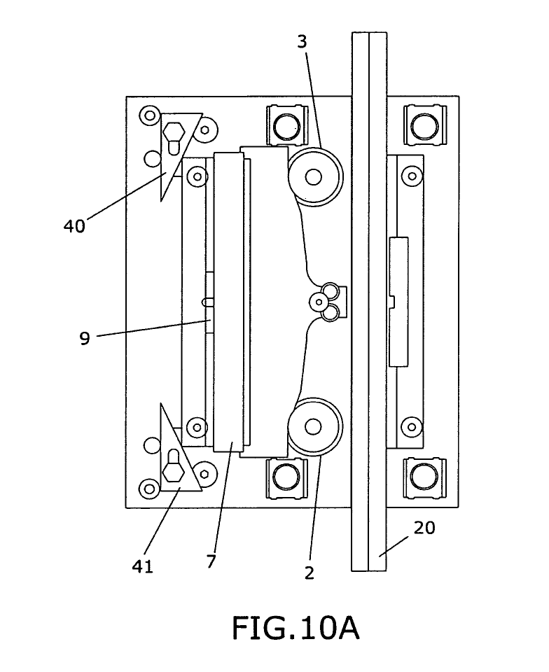

FIG. 9 shows an alternative embodiment applicarle as a safety device for a single direction (downward), the functional characteristics of which are identical to those described above.

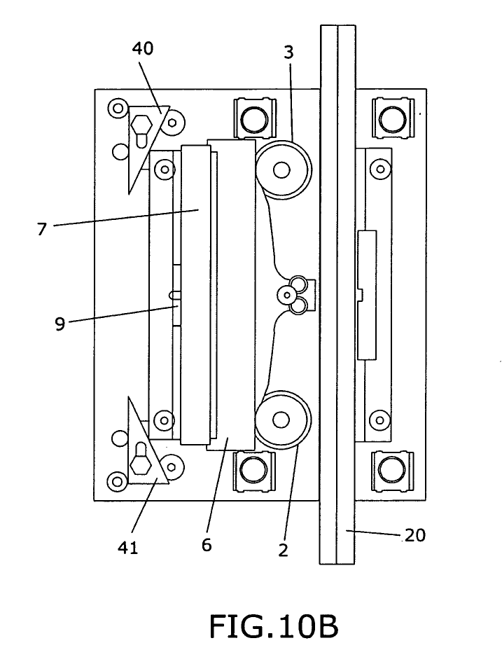

FIGS. 10A and 10B show two alternative embodiments in which the elastic element is placed behind the rollers.

The essence of the invention may be executed by other embodiments that may differ from that provided by way of example in the description, which would also be included in the scope of protection sought. Likewise, it may be constructed in any shape and size and with the most suitable materials, as this is all included in the spirit of the claims.

The materials used to manufacture the components of the safety device, their shape and dimensions and any accessory details that may be required are independent of the object of the invention.

The essence of this invention is not affected by variations in the materials, shape, size and arrangement of the component elements, described in a non-limiting manner that should allow its reproduction by an expert.

1. Progressive bidirectional safety gear, from among systems that allow an elevator to brake against guiderails in both an upward and downward direction, characterised in that it is formed by:
A main block composed of a floating brake-shoe assembly disposed on an elastic element, both placed on a side of the guiderail, and a set of rollers placed on the other side of the guiderail, wherein the rollers move independently;
A linkage system formed by a pullrod joined by a pin to a lever provided with a link through which run the ends of rods which are in turn connected to the rollers, the union of the rods and rollers passing through curved slits made in an intermediate piece of the linkage system;
Means for maintaining the linkage system in its central or resting position.

2. Progressive bidirectional safety gear according to claim 1, characterised in that the elastic element is formed by two beams placed opposite each other with their ends resting against one another, separated by a certain length by means of end supports (8).

3. Progressive bidirectional safety gear according to claim 1, characterised in that the elastic element is formed by two beams, one of which has a C-shaped configuration with stair-shaped ends, and rests directly on the ends of the other sheet.

4. Progressive bidirectional safety gear according to claim 2, characterised in that the elastic element controls the force that the safety must exert by changing The supports distance of the back beam, the thickness of the beams, which can be the same or different, or the length of the beams.

5. Progressive bidirectional safety gear according to claim 1, characterised in that the means used to maintain the linkage in its central or resting position are disposed on one of the safety devices placed on one of the guiderails and comprise two parallel plates, an upper one integrally joined to the main linkage plate and which rests at its ends on the bottom plate by bushings, both plates and the bushings being crossed by screws which on their bottom end are provided with nuts that compress some springs, with one of the ends of the main square shaft that joins the safety devices associated with each guiderail placed between the two plates.

6. Progressive bidirectional safety gear according to claim 1, characterised in that to prevent the brake-shoe of the main safety device block from falling its lateral faces are wedge shaped.

7. Progressive bidirectional safety gear according to claim 1, characterised in that to prevent the brake-shoe of the main safety device block from falling an auxiliary piece or a stair-like design is used in the lateral face of the brake-shoe.

8. Progressive bidirectional safety gear according to claim 5, characterised in that the main square shaft that joins the safety devices associated to each guiderail is comprised of three segments, joined at their ends to the linkage of each safety device and crossing at one of their ends the space between the parallel plates of the means used to maintain the linkage in its central or resting position.

9. Progressive bidirectional safety gear according to claim 1, characterised in that in that the assembly of the main safety device block is supported by the main linkage plate, which is housed in two slits made in the block to allow its lateral motion, which acts as a centring system in the engagementing process, its motion being limited on one side by stop wedges (40) and (41) and on the other by springs (42) and (43) attached to the main linkage plate.

10. Progressive bidirectional safety gear according to claim 1, characterised in that the rollers of the main block are replaced with moving brake-shoes.

11. Progressive bidirectional safety gear according to claim 1, characterised in that the elastic element is attached at its central part and is free at its ends, and in that this elastic element may be longer than the safety block.

12. Progressive bidirectional safety gear according to claim 3, characterised in that the elastic element controls the force that the safety must exert by changing The supports distance of the back beam, the thickness of the beams, which can be the same or different, or the length of the beams.
